(19) United States
(12) Patent Application Publication
(10) Pub. No.: US 2010/0118543 A1
(43) Pub. Date: May 13, 2010

(54) METHODOLOGY OF OPTICAL FEEDBACK FOR LED LIGHTING

(75) Inventor: Seow Kheng Hong, Perai (MY)

Correspondence Address: HAMRE, SCHUMANN, MUELLER & LARSON, P.C., P.O. BOX 2902, MINNEAPOLIS, MN, 55402-0902, US

(73) Assignee: ITRAMAS INTERNATIONAL, INC., Petaling Jaya (MY)

(21) Appl. No.: 12/267,192

(22) Filed: Nov. 7, 2008

(51) Int. Cl. F21V 7/00

(52) U.S. Cl. 362/296.01

(57) ABSTRACT

The present invention relates generally to a methodology of reflecting light that is transmitted by a lighting means such as at least one light emitting diodes (LED) in a confined space, back a sensory means such as colour sensor, which is located behind the lighting means. The sensory means is placed behind the lighting means in order not to block the light beam from the lighting means and avoid creating dark zone.

### TECHNICAL FIELD OF INVENTION

The present invention relates generally to a methodology of reflecting light that is transmitted by a lighting means such as at least one light emitting diode (LED) in a confined space, back to a sensory means such as colour sensor, which is located behind the lighting means. The sensory means is placed behind the lighting means in order not to block the light beam from the lighting means and avoid creating dark zone.

### BACKGROUND OF THE INVENTION

Light emitting diode (LED) lamp is a type of solid state lighting that comprises light emitting diodes as source of lighting instead of electrical filaments or gas. LED lamps usually contain clusters of LEDs in an appropriate housing. The housing used for the LED lamp usually has an opening to direct the light from the LEDs to the intended direction. The said housing opening is usually made of transparent material in order to transfer a large percentage of light beams from the LED lamp to the intended space.

U.S. Pat. No. 6,741,351 discloses a white light emitting luminaire with light sensor configurations for optical feedback. The luminaire includes a condenser lens to direct the combined light output from the array of LEDs to a target light guide, which has a partial reflecting element to reflect certain portion of the light output from the condenser lens back towards the LED array. The specification of U.S. Pat. No. 6,741,351 is hereby incorporated by reference into this specification.

The arrangement in U.S. Pat. No. 6,741,351 needed an extra condenser lens and partial reflecting element in order to reflect back a small percentage of light back to towards the LED array. There is a need for a more efficient and cost effective method to reflect the light back the LED array by having less components.

Furthermore, the angle of lighting from the each LED is usually in the range of 90°-120°, which is relatively wide. Although this wide angle light can be used to light up a larger area, high energy consumption is needed in order to light the area because a wide angle of lighting will lead to divergence of light and causes low brightness.

The present invention overcomes, or at least partly alleviates the above shortcomings by providing a methodology of light feedback system for lighting means, whereby the light that is transmitted from the lighting means such as LED array is being reflected back to the sensory system located at the back of the LED array by a reflecting means, which is part of the housing; said sensory system comprises a light guide with a large viewing angle and a colour sensor; and said light from the lighting means can be transmitted through an optional focus lens to provide a narrower lighting angle (e.g. 10° (spot model) or 30° (flood model) viewing angle).

### SUMMARY OF THE INVENTION

Accordingly, it is the primary aim of the present invention to provide a methodology of light feedback system for lighting means wherein said reflecting means (100, 204) can reflect back to a sensory means located behind said lighting means.

It is yet another object of the present invention to provide a methodology of light feedback system for lighting means whereby said light feedback system is made of acrylic, which is light, high transparency and durable.

It is yet another object of the present invention to provide a methodology of light feedback system for lighting means whereby said light feedback system can be made of other materials with similar characteristics to acrylic.

It is yet another object of the present invention to provide a methodology of light feedback system for lighting means whereby said light feedback system is part of the lighting means housing to maintain a low amount of component to the lighting means.

It is yet another object of the present invention to provide a methodology of light feedback system for lighting means whereby said light feedback system will reflect and converge the light beams from the lighting means to the sensory system.

It is yet another object of the present invention to provide a methodology of light feedback system for lighting means further comprising an optional focus lens attached to the reflecting means (204) to provide a narrower lighting angle such as 10° or 30° viewing angle for the LED lamp to provide more focused and sharper lighting and higher brightness.

It is yet another object of the present invention to provide a methodology of light feedback system for lighting means whereby said sensory system comprises a light guide with a large viewing angle in order to absorb more light reflected from the reflecting means.

It is yet another object of the present invention to provide a methodology of light feedback system for lighting means whereby said sensory system further comprises a colour sensor to measure correlated colour temperature (CCT) of reflected light.

Other and further objects of the invention will become apparent With an understanding of the following detailed description of the invention or upon employment of the invention in practice.

According to a preferred embodiment of the present invention there is provided,

A methodology of light feedback system for lighting means (102), the steps comprising:
transmitting light from lighting means (102) through a confined space;
having a certain percentage of said light to be transmitted back towards the lighting means (102) by a reflecting means (100, 204);

characterized in that
said reflecting means (100, 204) can reflect back to a sensory means (106) located behind said lighting means (102).

In another embodiment, the present invention provides,

A methodology of light feedback system for lighting means (102), the steps comprising:
transmitting light from lighting means (102) through a confined space;
having certain percentage of said light to be transmitted back towards the lighting means (102) by a reflecting means (204);

characterized in that
said reflecting means (204) can reflect back to a sensory means (106) located behind said lighting means (102).
said reflecting means (204) is attached to a focus lens to be placed in front of the lighting means (102) to create a narrower light beam.

### BRIEF DESCRIPTION OF THE DRAWINGS

Other aspects of the present invention and their advantages will be discerned after studying the Detailed Description in conjunction with the accompanying drawings in which:

FIG. 1A is a diagram showing the perspective view of the LED lamp (110).

FIG. 1B is a diagram showing the cross sectional view of the LED lamp (110).

FIG. 2 is a diagram showing the components of the LED lamp (110) in another embodiment.

FIG. 3 is a diagram showing the focus lens used in the LED lamp (110) in the second embodiment.

### DETAILED DESCRIPTION OF THE DRAWINGS

In the following detailed description, numerous specific details are set forth in order to provide a thorough understanding of the invention. However, it will be understood by those or ordinary skill in the art that the invention may be practiced without these specific details. In other instances, well known methods, procedures and/or components have not been described in detail so as not to obscure the invention.

The invention will be more clearly understood from the following description of the preferred embodiments thereof, given by way of example only with reference to the accompanying drawings. In the descriptions that follow, like numerals represent like elements in all figures. For example, where the numeral (2) is used to refer to a particular element in one figure, the numeral (2) appearing in any other figure refers to the same element.

Description of one or more embodiments of the invention is provided as follows along with diagrams that illustrate the principles and application of the invention. The invention is described in connection with such embodiments, but invention is not limited to any embodiment. The scope of the invention is limited only by the claims and the invention encompasses numerous alternatives, modifications and equivalents. Numerous specific details are set forth in the following description in order to assist in creating a thorough understanding of the invention. These details are provided for the purpose of example and the invention may be practiced according to the claims without some or all of these specific details.

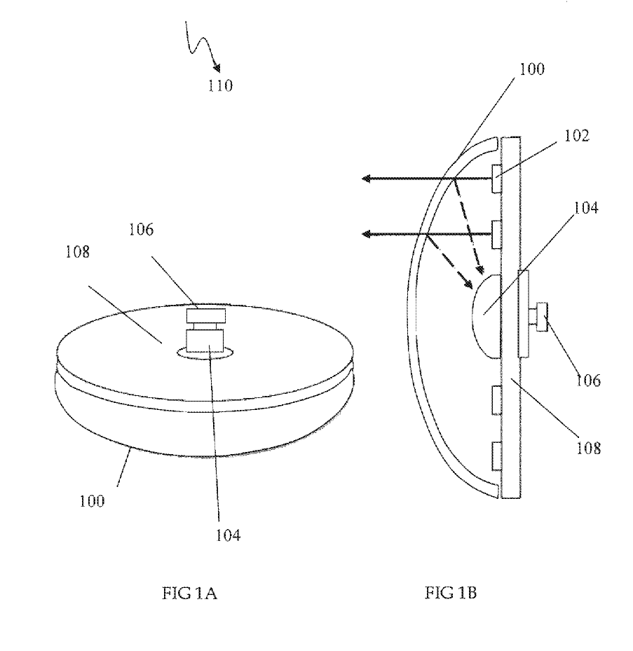

Referring now to FIG. 1A, there is shown a diagram of the perspective view of the LED lamp (110). The LED lamp (110) comprises an LED plate (108), concave reflecting means (100), light guide (104) and sensory means (106). The LED plate (108) has a flat surface and has an opening at the centre in order to fit the light guide (104) and sensory means (106). The concave reflecting means (100) is concave in shape and the circumference fits with the size of the LED plate (108). The LEDs (102) are placed on the LED plate (108) and facing towards the reflecting means (100).

Referring now to FIG. 1B there is shown a diagram of the cross sectional view of the LED lamp (110). The plurality of LEDs (102) is placed on the LED plate (108) and facing towards the concave reflecting means (100). The light beam from the LED (102) is emitted towards the concave reflecting means (100) 95%-97% of the light beam will be transmitted through the concave reflecting means (100) in order to provide lighting to the environment. 3%-5% of the light beams will be reflected back, but towards the light guide (104) due to the shape of the concave reflecting means (100). The light guide (104), which is located at the centre of the LED plate (108), will receive most the reflected light beams from the concave reflecting means (100). The light guide (104) with a large view angle is chosen because it is able to detect a larger amount of light reflected. The light guide (104) will eventually transfer the light beam to the sensory means (106), such as colour sensor, which is located at the other side of the LED plate (108). By having the said flow, the sensory means (106) will be able to measure the CCT of the light beam that is being emitted from the LEDs (102).

The concave reflecting means (100) is made of acrylic material, which is a type of useful and clear plastic that resembles glass. Acrylic material is used for the concave reflecting means (100) because it is transparent up to 97% of visible light, which makes it an efficient material for lighting devices. Besides, the 3% reflection of visible light is also beneficial to reflect back light to the light source for any sort of sensory means (106) to measure the reflected light. Besides acrylic, other materials that exhibit similar characteristics to acrylic can also be used.

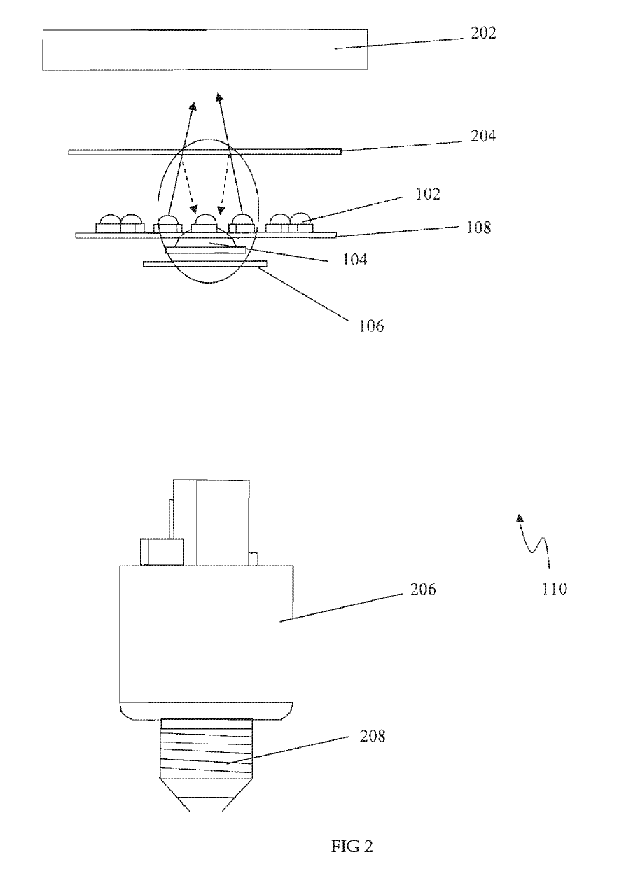

Referring now to FIG. 2, there is shown a diagram showing the components of the LED lamp (110) in another embodiment. In this embodiment, the LED lamp (110) comprises an array of LEDs (102), an LED plate (108), lens, sensory means (106), flat acrylic reflecting means (204), housing, top cover (202), power supply housing (206) and connector (208). The array of LEDs (102) is attached to the LED plate (108) while the LED plate (108) has an opening in the centre in order to fit the lens and sensory means (106). The LED lamp (110) housing is attached to the top cover (202) and the flat acrylic reflecting means (204) is flat and placed with the top cover (202). The flat acrylics reflecting means (204) have a plurality of protruding edges in the shape of circles in different sizes that converges the light beams emitted from the lighting means (102) and reflect the converged light beams back to the lens. The flat acrylic reflecting means (204) may be without the plurality of protruding edges in the shape of circles in different sizes but percentage of light reflected will be less.

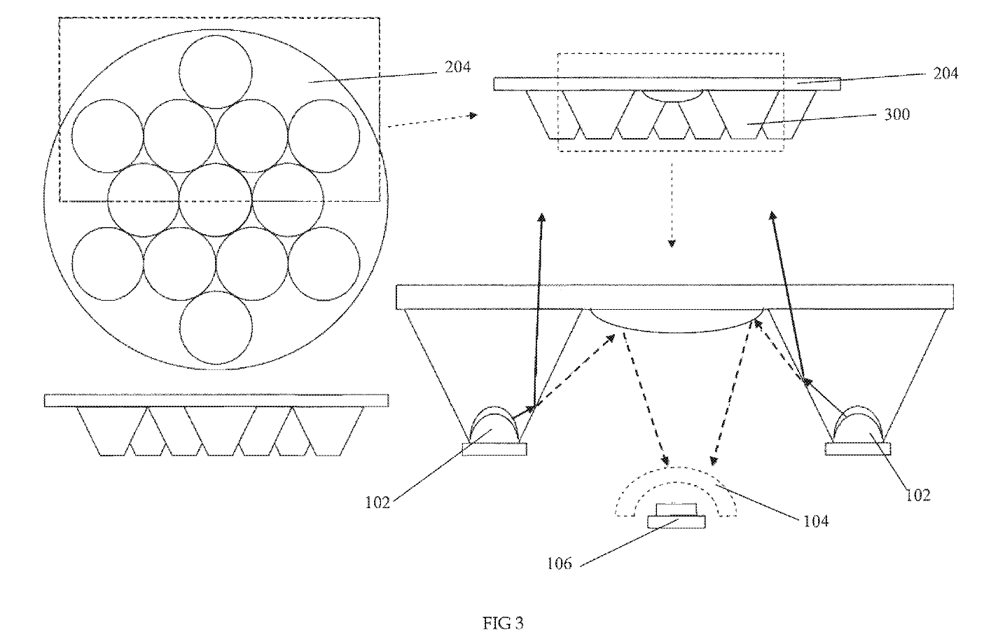

Referring now to FIG. 3, there is shown a diagram showing the focus lens (300) used in the LED lamp (110) in the second embodiment. The quantity of focus lens (300) used should correspond to the quantity of LEDs (102) in the LED lamp (110). In another words, each LED (102) should have one accompanying focus lens (300). The focus lens (300) is in the shape of part of a hollow cone whereby there is an opening at the tips of the hollow cone. The opening is made such that it fits to the size of the LED (102). The base of the focus lens (300) is attached to the flat reflecting means (204). The arrangement of the focus lens (300) is according to the arrangement of the LEDs (102) on the LED plate (108). In the centre of the flat reflecting means (204) is placed a convex mirror that will produce full reflection of the lights received to the sensors (106). Of the entire light beam that is emitted by the LED (102), 95%-97% of it will be maintained in the focus lens (300) and eventually be emitted out from the LED lamp (110). In the meantime, 3%-5% of the light beam will pass out of the focus lens (300) and the light beams that meet the convex mirror will be reflected fully and converged to the sensor (106). There can be an optional light guide (104) in the pathway between the convex mirror and sensor (106) in order to direct more light to the sensor (106).

It will be understood by those skilled in the art that changes and modifications may be made to the invention without departing from the spirit and scope of the invention.

Therefore it is intended that the foregoing description is merely for illustrative purposes and not intended to limit the spirit and scope of the invention in any way but only by the spirit and scope of the appended claim.

What is claimed is:

1. A methodology of light feedback system for lighting means, the steps comprising:
i. transmitting light from lighting means through a confined space;
ii. having a certain percentage of said light to be transmitted back towards the lighting means by a reflecting means;
wherein
said reflecting means can reflect back to a sensory means located behind said lighting means.

2. A methodology of light feedback system for lighting means as claimed in claim 1 wherein said reflecting means are made of acrylic material.

3. A methodology of light feedback system for lighting means as claimed in claim 1 wherein said reflecting means have a plurality of protruding edges in the shape of circles in different sizes that converges the light beams emitted from said lighting means and reflect the converged light beams back to said sensory means.

4. A methodology of light feedback system for lighting means as claimed in claims 1 wherein said reflecting means can reflect 3% to 5% of light beam from lighting means.

5. A methodology of light feedback system for lighting means as claimed in claim 1 wherein said sensory means are colour sensors to detect correlated colour temperature (CCT).

6. A methodology of light feedback system for lighting means as claimed in claim 1 further comprises a plurality of focus lens between the plurality of lighting means and the reflecting means.
